(19) United States
(12) Patent Application Publication
(10) Pub. No.: US 2009/0074979 A1
(43) Pub. Date: Mar. 19, 2009

(54) Method For Controlling A Robot Tool Center Point

(76) Inventors: Arnulf Krogedal, Sandnes (NO); Jan Inge Tjolsen, Stavanger (NO)

Correspondence Address: ST. ONGE STEWARD JOHNSTON & REENS, LLC, 986 BEDFORD STREET, STAMFORD, CT, 06905-5619, US

(21) Appl. No.: 12/273,063

(22) Filed: Nov. 18, 2008

Related U.S. Application Data
(63) Continuation of application No. PCT/IB2007/051876, filed on May 16, 2007.

(30) Foreign Application Priority Data
May 19, 2006 (EP) 06010330.6

(51) Int. Cl. B05D 1/02; G05B 19/04; B25J 9/02; B25J 17/02; B25J 19/00

(52) U.S. Cl. 427/427.2; 700/255; 901/43; 901/29; 901/16

(57) ABSTRACT

A method for controlling a painting system including an industrial robot or manipulator arm arranged with a wrist section and carrying a paint applicator arranged on the robot wrist is described. Paint is applied by the applicator to a substantially circular or elliptical area on the surface, the center of the area being defined as a Tool Center Point. The wrist section is arranged capable of moving and orienting the paint applicator. In the method, the paint applicator is moved by the manipulator arm so that the Tool Center Point moves along a planned path so coating a part of the surface. The planned path may include one or more bends. The path taken by the robot wrist may be controlled to follow a different path from the path taken by the Tool Center Point. A system and a computer program for carrying out the method are also described.

### CROSS-REFERENCE TO RELATED APPLICATIONS

The present application is a continuation of pending International patent application PCT/IB2007/051876 filed on May 16, 2007 which designates the United States and claims priority from European patent application EP 06010330.6 filed on May 19, 2006, the content of which is incorporated herein by reference.

### FIELD OF THE INVENTION

The invention concerns industrial painting systems, such as automated systems for painting automobiles. In particular it concerns a method for controlling a paint applicator while applying paint in an automated painting process and a system for carrying out that method.

### BACKGROUND OF THE INVENTION

Industrial robots with an arm or manipulator are often used to paint objects such as automobiles in industrial painting processes. When painting an object surface using a robot or manipulator arm it is desirable to move an applicator over the surface to be painted with a constant velocity in order to ensure good quality of the paint result. It has been common practice when a traditional type paint spray gun was used to switch the paint flow on-off with spray gun trajectory. Thus it was possible to switch paint off as the spray gun left the object to be painted, let the spray gun trajectory make a turn or U-turn, and then switch paint on again when the spray gun was back over the object and had reached full (programmed) velocity.

For paint process reasons such as transfer efficiency and paint gloss, etc. the bell applicator is used for robot-painting today much more than traditional spray gun type applicators. A drawback with the bell applicator is that the control of paint flow is slower, with the result that it is not practical to switch paint on/off synchronously with applicator trajectory. The preferred solution for a bell applicator is to let the paint flow continuously, and aim at keeping speed over the surface as constant as possible during the painting program.

This requires a very high bandwidth of the robot servo motors powering the robot joints and wrist which, for some movements (e.g., a U-turn) requires the motors in all of the robot joints involved to accelerate and decelerate at very high rates. It is complex and expensive to design a robot to such specifications including for example very high acceleration capabilities.

### SUMMARY OF THE INVENTION

According to one or more embodiments of the present invention an improvement is provided to methods for controlling a robot arm or manipulator for painting an object.

According to embodiments of the present invention one or more improved methods for controlling a robot Tool Center Point (TCP) are described. A paint spray gun or applicator carried by a robot is normally passed over the surface to be painted and oriented perpendicular to the plane of the surface. However, the inventors have found that paint process is not very critical with regards to limited deviation in orientation of the applicator, so that by allowing for and planning for a certain deviation from an ideal or perpendicular position in programmed orientation a kinematic redundancy can be obtained.

According to an aspect of the present invention a method for painting a workpiece with an automated painting system comprising an industrial robot or manipulator arm arranged with a wrist section and carrying a paint applicator arranged on the wrist section of the manipulator arm is provided. The paint applicator is arranged to coat a surface on the workpiece, and paint is applied to a substantially circular or elliptical area on the surface, the center of the area being defined as a Tool Center Point. The wrist section is arranged capable of orienting the paint applicator and the paint applicator is moved by the manipulator arm so that the Tool Center Point moves along a planned path so coating a part of the surface. The method is further characterised by calculating a planned path comprising one or more turns such that a path taken by a fixed point on the robot wrist above the surface during a turn in the planned path is shorter than a path taken by the Tool Center Point along the surface.

According to an embodiment an improved method is provided wherein the fixed point on the wrist section is moved during part of the movement through a bend in the planned path with a velocity which is not the same velocity as that of the Tool Center Point along the planned path.

According to another embodiment an improved method is provided wherein a velocity of the fixed point on the robot wrist along the planned path is controlled to be substantially the same as the velocity of the Tool Center Point during a part of a straight path and a velocity which is less than the velocity of the Tool Center Point during a turn in the path.

According to another embodiment an improved method is provided wherein an orientation parameter of the wrist section, being a measure of deviation of the applicator axis from perpendicular to the surface, is optimised during movement in the planned path to one or more values different from the value of the orientation parameter during movement of the wrist section along a straight part of the planned path.

According to another embodiment an improved method is provided wherein the orientation parameter is optimised during movement in the planned path dependent on a position of the fixed point on the robot wrist relative to a part of the path comprising: a straight approach to a bend; a bend; a straight part upon leaving the bend; or a straight part of the path.

According to another embodiment an improved method is provided wherein the Tool Center Point is maintained at a constant or near constant velocity during movement through the bend in the planned path.

According to another embodiment an improved method is provided wherein the velocity of the wrist section is increased on completing the bend in the planned path by adding a positive orientation deviation in the first x direction and a negative orientation deviation in the second y direction to the wrist section.

According to one or more other embodiments an improved method is provided wherein a path for the wrist section is constrained by the optimised constant or near constant velocity of the Tool Center Point and for one or more joints of the manipulator arm by a limit selected from the group consisting of: a joint angle, an angular velocity, an angular acceleration, and a torque.

According an embodiment an improved method is provided wherein information concerning a Tool Center Point and/or a Wrist Center Point is displayed on a graphic user interface for the purpose of programming, monitoring, or controlling the industrial robot or manipulator arm carrying a paint applicator.

According to another aspect of the invention, a system is provided for painting a workpiece with an automated painting system comprising an industrial robot or manipulator arm arranged with a wrist section and carrying a paint applicator arranged on the wrist section of the manipulator arm. The paint applicator is arranged to coat a surface on the workpiece, where paint is applied to a substantially circular or elliptical area on the surface, and the center of the area being defined as a Tool Center Point. The wrist section is arranged capable of orienting the paint applicator and the paint applicator is moved by the manipulator arm so that the Tool Center Point moves along a planned path so coating a part of the surface, and means are provided for controlling the robot or manipulator arm to operate according to a planned path. The system comprises means for calculating a planned path comprising one or more turns such that a path taken by a fixed point on the robot wrist (WCP) above the surface is shorter than a path taken by the Tool Center Point (TCP) along the surface.

A prime advantage of the improved method and system for carrying out the method is that painting with an industrial robot may be carried out more quickly. Coverage can be achieved more quickly by providing faster movement of the robot through turns or bends in the paint path. Another technical advantage of the improved method is that by maintaining a constant velocity through the bend a more uniform coating or paint thickness on the surface is achieved.

Paint wastage is also reduced by means of the improved method which is another very important advantage. Overspray, coating that continues while the applicator is not directly above the surface to be coated, is eliminated. This feature greatly reduces waste of paint, with all the environmental benefits that follow therefrom. Continuous application is maintained, which reduces the necessity for cleaning and flushing the applicator or supply lines, also resulting in reduced paint waste and solvent use.

Another advantage is that rapid painting may be achieved by use of the described control methods which do not require investment in higher performance robots or robot servo motors for particular joints.

In another aspect of the invention the method offers extended opportunities for optimization. When details about the dynamics of the robot are also known (a robot has normally different acceleration capability in different directions and in different positions of the working envelope), then this knowledge can be utilized in the path planning to generate a Tool Center Point trajectory that is optimized with regards to constant velocity for the Tool Center Point during U-turns.

In another development the invention is used with a robot arranged with a modified robot wrist. The modification comprises that the wrist axes are lighter in weight. When the inventive control methods are employed together with the higher bandwidth of the lighter wrist axes this provides a significantly higher bandwidth of the overall resulting Tool Center Point motion.

In a preferred embodiment of the method of the invention the method may be carried out by a computing device comprising one or more microprocessor units or computers. The control unit(s) of the robot and/or automated painting system comprise memory means for storing one or more computer programs for carrying out the improved methods for controlling the operation of a mechanical press. Preferably, such computer programs contain instructions for the processor to perform the method as mentioned above and described in more detail below. In another embodiment the computer program is provided on a computer readable data carrier such as a DVD, an optical or a magnetic data device.

### BRIEF DESCRIPTION OF THE DRAWINGS

Embodiments of the invention will now be described, by way of example only, with particular reference to the accompanying drawings in which:

FIG. 1a-c and FIG. 1f are schematic diagrams related to an improved method for controlling a paint applicator according to an embodiment of the invention;

FIG. 1e, is a schematic diagram for an ideal movement from a controlled paint applicator which may not be attainable in practice;

FIG. 1d, Prior Art, is a schematic diagram showing a known method for controlling a paint applicator according to the prior art;

FIG. 2 is a schematic diagram showing a robot carrying a paint applicator in a system according to an embodiment of the invention;

FIG. 3 is a schematic diagram similar to that of FIG. 1a showing deviations in orientation in x and y planes; and

FIG. 4 is a flowchart illustrating steps of an improved method for controlling a paint applicator according to an embodiment of the invention.

### DETAILED DESCRIPTION OF THE INVENTION

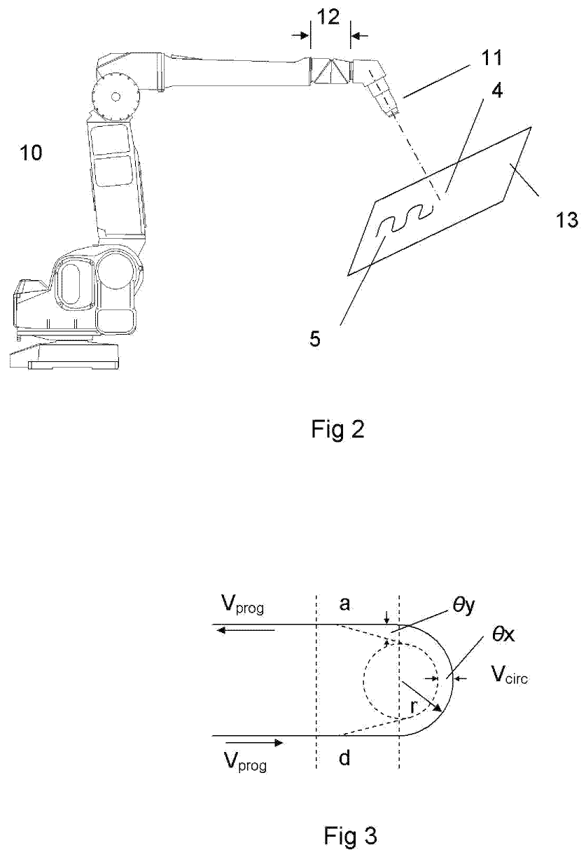

FIG. 2 shows schematically an industrial robot carrying a paint applicator. The figure shows a robot 10 with an arm carrying a paint applicator 11. The paint applicator is attached to a wrist part 12 arranged on the robot arm. The figure also shows an object with a surface 13 which is to be painted. A planned paint path 5 is indicated on the surface of the object. A center line of the applicator drawn between the applicator 11 and the surface to be painted intersects with the surface at a point, and this point is called the Tool Center Point 4.

The robot moves the arm and the wrist and orients (points) the applicator 11 so that the tool center point follows the pre-programmed path 5 on the object surface. In this diagram the paint applicator is shown at an angle which is approximately perpendicular to the plane of the paint surface. In other words, the orientation of the paint applicator is perpendicular relative the surface to be painted. Normally a fixed point on the wrist, the Wrist Center Point, and the Tool Center Point are all be aligned in one single orientation.

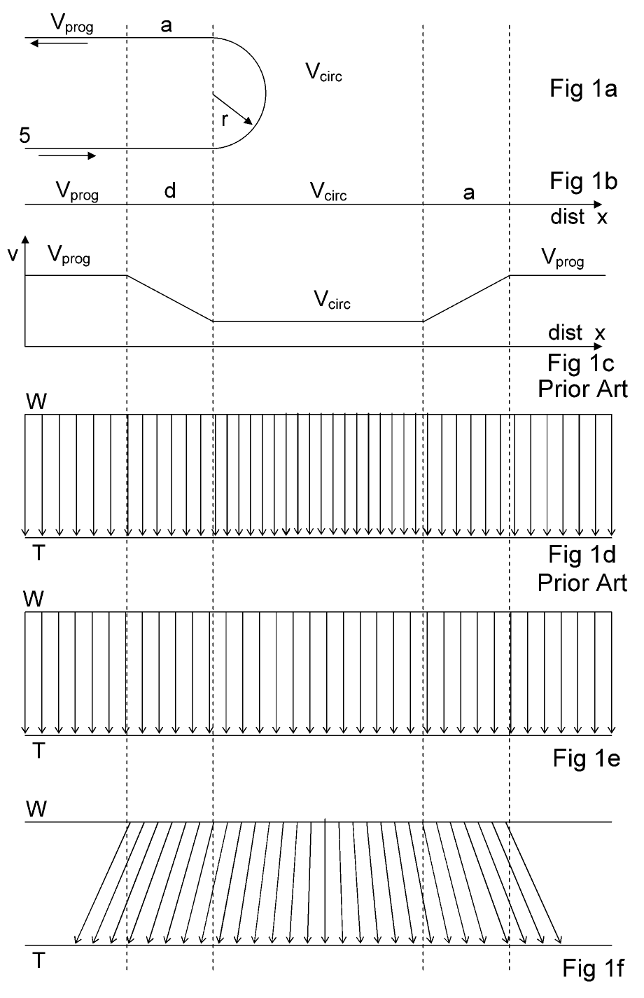

FIGS. 1a-1f shows a series of schematic diagrams to explain one or more methods of the invention, which is primarily shown in FIG. 1f. FIG. 1a shows a semi-circular bend in a planned paint path 5. As described above, the Tool Center Point is a point on the paint surface. To be more precise the Tool Center Point is the center point on the surface of a substantially circular or elliptical layer of paint applied to the surface. In this description, the term Wrist Center Point (WCP) is used to describe a designated fixed point on the robot wrist. Wrist Center Point is sometimes described as the point (position) inside a spherical robot wrist at which all the three wrist axes intersect. The Wrist Center Point is a concept in modelling of the robot kinematics. The Wrist Center Point may also be referred to as if the Wrist Center Point is a point on the applicator, and more precisely a point which is much closer to the wrist than it is to the Tool Center Point. In this description the term Wrist Center Point (WCP) is used to describe a given fixed point which may be constructed as any of: a fixed point on the end of the robot arm, on the robot wrist, or on the applicator.

FIG. 1a shows the planned path 5 which includes a U-turn. Due to the limited acceleration capability of the robot, the programmed velocity of the Wrist Center Point cannot be maintained during the half circle of the turn or bend.

Using centripetal acceleration

$$a = \frac{{V}^{2}}{r} ⇒$$

Max velocity, V_{circ}=\sqrt{a_{—}a*r}

where a_a is the available acceleration, and r is the radius.

The programmed velocity V_{prog} is reduced to a maximum velocity V_{circ} during a deceleration phase d before the circular path is entered. Velocity V_{circ} is then increased after the circular path is finished by acceleration a up to V_{prog}.

FIG. 1b is the planned path 5 from FIG. 1a represented as a straight line. This line may be regarded as the basis for the x axis of diagrams FIGS. 1c-f.

FIG. 1c (Prior Art) shows the velocity profile versus distance for the Tool Center Point and Wrist Center Point points according to prior art. Strictly speaking the indicated velocity is not completely accurate in the acc/de-acc phases, because it is graphed as if the abscissa was time (linear), whereas, since the abscissa is distance, it should have been shown as a parabolic function of the form:

V=\sqrt{2*a*s}

However the linear acc/de-acc representation is sufficient to describe the context of the technical functions carried out in embodiments of the invention.

FIG. 1d (Prior Art) shows a prior art method. The upper line W shows the position of the Wrist Center Point along the stretched out path at equally spaced time instants. The lower line T is the corresponding position of the Tool Center Point at the same instants. The arrow or vector from W to T indicates the orientation of the paint spray (the robot tool) which in this case is perpendicular to the path. The schematic diagram is not to scale, however, it is intended to show that it should be possible to identify the different phases by looking at the distances and variation in distance between the arrows.

FIG. 1e shows an ideal or desired path which may, in practice, not be possible to attain exactly. The figure indicates a constant speed through the U-turn. The diagram also shows FIG. 1e to have a smaller number of arrows (vectors) than the diagram of FIG. 1d, which represents then that traversing the path of FIG. 1e will require more time (at the same velocity).

FIG. 1f illustrates a planned path according to an embodiment of the invention. While approaching the U-turn, the Wrist Center Point will have a lead relative to the Tool Center Point resulting in a deviation in orientation, which is visualized here by deviation from the perpendicular. The Wrist Center Point is allowed to decelerate, d, make the circle and accelerate a, while the Tool Center Point runs with constant speed indicated by equal spacing between the arrows at the Tool Center Point line.

At the completion of the bend the Wrist Center Point lags behind the Tool Center Point. This gives a deviation in orientation with the opposite sign to that of the start, i.e., the approach to the turn. The Wrist Center Point lag must be handled by the next paint stroke, so that the Wrist Center Point is once more leading the Tool Center Point again at the time when it approaches the next U-turn.

Thus the planned path includes or permits a deviation in orientation from a planned orientation of the applicator. Instead of the normal orientation perpendicular to the plane of the surface to be painted, the applicator is tilted when it is moved through a bend, expressed more precisely as a deviation in orientation of the Wrist Center Point while the Tool Center Point follows the planned path exactly.

FIG. 3 shows the FIG. 1a with deviations in orientation indicated in terms of x and y. Thus, and in comparison to FIG. 1a, the figure also shows with a dashed line inside the solid line path planned for the Tool Center Point. The path shown with the dashed line schematically represents a Wrist Center Point path. In this example, the path deviates in both the x direction, indicated as amount θx, and also in the y direction, indicated as θy. The Wrist Center Point in this example follows a shorter path with deviations in both x and y directions. It is also possible to have a shorter path that deviates in the x direction only, i.e., the Wrist Center Point path runs inside of the Tool Center Point path on the bend, and so has a radius of less than r. However the straight Wrist Center Point path would then not be “inside” the straight Tool Center Point path during the constant or near constant V_{prog} speed or the acceleration/deceleration parts of the straight parts of the path.

It can be seen that in the deceleration phase, the x deviation becomes greater than zero, as indicated by the dashed line in FIG. 1a. A y deviation may also be applied during deceleration. Deviation in x may vary between zero and a maximum θx,m during deceleration. When the Wrist Center Point enters the turn, the y deviation goes to a maximum θy,m, and varies during the turn between yθ,m positive and yθ,m maximum negative. On leaving the turn the Wrist Center Point velocity is too low and must be accelerated. The x deviation of from minus maximum θx is increased to a zero x deviation.

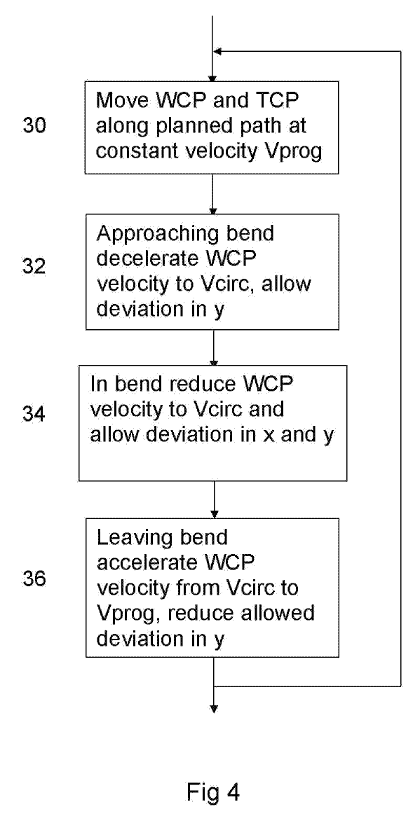

FIG. 4 shows a flowchart for a method according to an embodiment. The flowchart shows the method to comprise actions for moving the paint applicator 11 in terms of movements of the wrist section Wrist Center Point and the spray area Tool Center Point in the following schematic blocks:

Block 30: move the Wrist Center Point and Tool Center Point at a constant (max) velocity V_{prog} along the planned path;

Block 32: if approaching bend, decelerate (d) Wrist Center Point and reduce velocity to a maximum V_{circ}, allow deviation in x up to a max of +ve θx,m;

Block 34: in the bend maintain constant velocity V_{circ} for Wrist Center Point, reduce allowed deviation in x to change between +ve θx,m to zero, and allow deviation in y from between −θy,m up to +ve θy,m; and

Block 36: on leaving the bend accelerate Wrist Center Point from V_{circ} up to V_{prog} and increase allowed x deviation from −ve θx,m to zero.

The planned path has only been shown in the accompanying figures in terms of a planned paint path over a flat surface with two dimensions x and y. However, the methods described may also be applied to surfaces that are not flat and surfaces which may include concave or convex shapes.

In another embodiment, the planned path which includes or permits deviation in orientation by the Wrist Center Point may be optimized according to one or more other constraints. The Wrist Center Point path is calculated by optimizing a path for the wrist section while aiming for a constant or near constant velocity for the Tool Center Point and optimizing for one or more of the following criteria:

minimum total energy consumption for the robot joints involved;

minimum weighted energy consumption for the robot joints involved;

minimum total acceleration for the joints involved;

minimum weighted acceleration for the joints involved;

minimum total angular movement for the robot joints;

minimum weighted angular movement for the robot joints;

minimum linear acceleration of the Wrist Center Point; and

minimum deviation in orientation versus programmed orientation.

There are several variations and modifications which may be made to the disclosed solutions, and embodiments of the invention may also be used to coat different types of paint, two-component paint, basecoat, primer, clearcoat and so on. Similarly the above described solutions may also be adapted to coat or spray other substances such as protective coatings, sealants, adhesives and even abrasive materials.

Methods of the invention may be supervised, controlled or carried out by one or more computer programs. One or more microprocessors (or processors or computers) comprise a central processing unit (CPU) connected to or comprised in the paint application system described, which processors, PLCs or computers perform the steps of the methods according to one or more aspects of the invention, as described for example with reference to FIG. 4. It is to be understood that the computer programs for carrying out methods according to the invention may also be run on one or more general purpose industrial microprocessors or PLCs or computers instead of one or more specially adapted computers or processors.

The computer program comprises computer program code elements or software code portions that make the computer or processor perform the methods using equations, algorithms, data, stored values, calculations and the like for the methods previously described, and for example in relation to the flowchart of FIG. 4. The computer program may include one or more small executable programs, such as a Flash program. A part of the program may be stored in a processor as above, but also in a ROM, RAM, PROM, EPROM or EEPROM chip or similar memory means. The or some of the programs in part or in whole may also be stored locally (or centrally) on, or in, other suitable computer readable media, such as a magnetic disk, CD-ROM or DVD disk, hard disk, magneto-optical memory storage means, in volatile memory, in flash memory, as firmware, or stored on a data server. Other known and suitable media, including removable memory media such as Sony Memory Stick®, a USB memory stick and other removable flash memories, hard drives, etc., may also be used. The program may also in part be supplied from a data network, including a public network such as the Internet. The computer programs described may also be arranged in part as a distributed application capable of running on several different computers or computer systems at more or less the same time.

It is also noted that while the above describes exemplifying embodiments of the invention, there are several variations and modifications which may be made to the disclosed solution without departing from the scope of the present invention as defined in the appended claims.

1. A method for painting a workpiece with an automated painting system comprising an industrial robot or manipulator arm arranged with a wrist section and carrying a paint applicator arranged on said wrist section of said manipulator arm, said paint applicator arranged to coat a surface on said workpiece, where paint is applied to a substantially circular or elliptical area on said surface, and the center of said area being defined as a Tool Center Point, and where said wrist section is arranged capable of orienting said paint applicator and in which method said paint applicator is moved by said manipulator arm so that the Tool Center Point moves along a planned path so coating a part of said surface, characterised by calculating said planned path comprising one or more turns such that a path taken by a fixed point on the robot wrist above said surface during a turn in said planned path deviates in at least one of x-direction and y-direction from the planned path, and the path taken by a fixed point on the robot wrist is shorter than said planned path taken by the Tool Center Point along said surface.

2. The method according to claim 1, wherein the fixed point on the robot wrist is moved during part of the movement through a bend in the planned path with a velocity which is not the same velocity as that of the Tool Center Point along the planned path.

3. The method according to claim 1, wherein a velocity of the fixed point on the robot wrist along the planned path is controlled to be substantially the same as the velocity of the Tool Center Point during a part of a straight path and a velocity which is less than the velocity of the Tool Center Point during a turn in the path.

4. The method according to claim 1, wherein an orientation parameter of said wrist section, being a measure of deviation of the applicator axis from perpendicular to said surface, is optimized during movement in the planned path to one or more values different from the value of the orientation parameter during movement of said wrist section along a straight part of the planned path.

5. The method according to claim 4, wherein the orientation parameter is optimized during movement in the planned path dependent on a position of the fixed point on the robot wrist relative to a part of the path comprising at least one of: a straight approach to a bend; a bend; a straight part upon leaving the bend; and a straight part of the path.

6. The method according to claim 4, wherein the orientation deviation of said wrist section during movement through the bend in the planned path is optimized to a value lying between a negative deviation and a positive deviation.

7. The method according to claim 6, wherein the Tool Center Point is maintained at a constant or near constant velocity during movement through the bend in the planned path.

8. The method according to claim 7, wherein the velocity of said wrist section during an approach to the bend in the planned path is reduced and an orientation deviation in a first direction is permitted up to a maximum value.

9. The method according to claim 8, wherein an orientation deviation in a second direction is permitted up to a maximum value.

10. The method according to claim 8, wherein the orientation deviation in a first direction of said wrist section is changed from zero up to a maximum and then to zero during movement along the bend.

11. The method according to claim 9, wherein the orientation deviation in a second direction of said wrist section is changed from a negative maximum up to positive maximum during movement along the bend.

12. The method according to claim 8, wherein the velocity of said wrist section is increased on completing the bend in the planned path by adding a positive orientation deviation in the first direction and a negative orientation deviation in the second direction to said wrist section.

13. The method according to claim 8, wherein a path for said wrist section is constrained by the optimised constant or near constant velocity of the Tool Center Point and for one or more joints of said manipulator arm by a limit of any selected from the group consisting of: a joint angle, an angular velocity, an angular acceleration, and a torque.

14. The method according to claim 13, wherein a path for said fixed point on the robot wrist is calculated by optimizing a path for said wrist section constrained by the constant or near constant velocity for the Tool Center Point and optimizing for at least one of:
total energy consumption for the involved robot joints,
weighted energy consumption for the involved robot joints,
total acceleration for the involved joints,
weighted acceleration for the involved joints,
total angular movement for the robot joints,
weighted angular movement for the robot joints,
linear acceleration of the fixed point on the robot wrist, and
deviation in orientation versus programmed orientation.

15. The method according to claim 1 wherein one or more computer programs are read into a computer or processor causing the computer or processor to carry out a method according to claim 1.

16. The method according to claim 1 wherein information concerning at least one of a Tool Center Point and a fixed point on the robot wrist is displayed on a graphic user interface for the purpose of programming, monitoring, or controlling said industrial robot or manipulator arm carrying a paint applicator.

17. A computer program which when read into a computer or processor will cause the computer or processor to carry out a method according to the steps of claim 1.

18. A computer readable medium comprising a computer program which when read into a computer or processor will cause the computer or processor to carry out a method according to the steps of any of claim 1.

19. A system for painting a workpiece with an automated painting system comprising an industrial robot or manipulator arm arranged with a wrist section and carrying a paint applicator arranged on said wrist section of said manipulator arm, said paint applicator arranged to coat a surface on said workpiece, where paint is applied to a substantially circular or elliptical area on said surface, and the center of said area being defined as a Tool Center Point, and where said wrist section is arranged capable of orienting said paint applicator and in which method said paint applicator is moved by said manipulator arm so that the Tool Center Point moves along a planned path so coating a part of said surface, and comprising means for controlling said robot or manipulator arm to operate according to a planned path, characterised by said system further comprising means for calculating said planned path Comprising one or more turns such that a path taken by a fixed point on the robot wrist above said surface during a turn in said planned path deviates in at least one of x-direction and y-direction from the planned path, and the path taken by a fixed point on the robot wrist is shorter than a path taken by the Tool Center Point along said surface.

20. The system according to claim 19, further comprising means for moving said wrist section during part of the movement through a bend in the planned path with a velocity which is not the same velocity as that of the Tool Center Point along a substantially straight part of the planned path.

21. The system according to claim 19, further comprising means for controlling a velocity of the fixed point on the robot wrist along the planned path to be substantially the same as the velocity of the Tool Center Point during a part of a straight path and a velocity which is less than the velocity of the Tool Center Point during a bend in the path.

22. The system according to claim 19, further comprising means for optimizing an orientation parameter of said wrist section during movement through a bend in the planned path to a different value from the value of the orientation parameter during movement of said wrist section along a straight part of the planned path.

23. The system according to claim 19, further comprising means for moving said wrist section such that an orientation parameter being a measure of deviation of the applicator axis from perpendicular to said surface is optimized during movement in the planned path to one or more different values from the value of the orientation parameter during movement of said wrist section along a straight part of the planned path.

24. The system according to claim 19, further comprising means for optimizing an orientation deviation of said wrist section during movement through the bend in the planned path to a value lying between a negative deviation and a positive deviation.

25. The system according to claim 19, further comprising means for maintaining the velocity of the Tool Center Point at a constant or near constant velocity during movement through the bend in the planned path.

26. The system according to claim 19, further comprising means for doing at least one of the following: reducing the velocity of said wrist section during an approach to the bend in the planned path; increasing the velocity of said wrist section on completing the bend in the planned path.

27. The system according to claim 19, further comprising means for doing at least one of the following: permitting an orientation deviation in a first direction up to a maximum value; and permitting an orientation deviation in a second direction up to a maximum value.

28. The system according to claim 19, further comprising means for optimizing a path for said wrist section while aiming for a constant or near constant velocity for Tool Center Point and optimizing at least one of:
total energy consumption for the involved robot joints,
weighted energy consumption for the involved robot joints,
total acceleration for the involved joints,
weighted acceleration for the involved joints,
total angular movement for the robot joints,
weighted angular movement for the robot joints,
linear acceleration of the fixed point on the robot wrist, and
deviation in orientation versus programmed orientation.

29. Use of a system according to claim 19 for controlling or programming an industrial robot to carry out an application or coating task selected from the group consisting of: applying a conductive or non-conductive fluid material, paint application, paint spraying, dry spraying, applying glue, applying sealant, applying a sealant containing PVC, applying anti-corrosion material, sand blasting or applying sand, applying abrasive material, and applying a wax.
